(19) United States
(12) Patent Application Publication
(10) Pub. No.: US 2026/0362258 A1
(43) Pub. Date: Nov. 12, 2026

(54) CRITICAL UPDATES NOTIFICATION FROM A TARGET ACCESS POINT (AP) MULTI-LINK DEVICE (MLD) DURING SEAMLESS ROAMING

(71) Applicant: Cisco Technology, Inc., San Jose, CA (US)

(72) Inventors: Binita Gupta, San Diego, CA (US); Brian D. Hart, Sunnyvale, CA (US)

(21) Appl. No.: 19/674,655

(22) Filed: May 12, 2026

Related U.S. Application Data
(60) Provisional application No. 63/804,549, filed on May 12, 2025.
(60) Provisional application No. 63/913,621, filed on Nov. 7, 2025.

(51) Int. Cl. H04W 36/00; H04W 36/08; H04W 88/06; H04W 88/10

(52) U.S. Cl. CPC H04W 36/0077; H04W 36/08; H04W 88/06; H04W 88/10

(57) ABSTRACT

Critical updates notification from a target Access Point (AP) Multi-Link Device (MLD) during seamless roaming may be provided. A current AP MLD may receive a critical update notification from a target AP MLD during seamless roaming of a non-AP MLD to the target AP MLD from the current AP MLD. The critical update notification may be indicative of a change in a critical parameter at the target AP MLD after a roaming preparation phase of the seamless roaming. The current AP MLD may create a management frame comprising the critical update notification. The current AP MLD may send the management frame comprising the critical update notification to the non-AP MLD.

### RELATED APPLICATION

This application claims benefit of U.S. Provisional Application No. 63/804,549 filed May 12, 2025, and U.S. Provisional Application No. 63/913,621, filed Nov. 7, 2025, which are incorporated herein by reference.

### TECHNICAL FIELD

The present disclosure relates generally to critical updates notification from a target Access Point (AP) Multi-Link Device (MLD) during seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for critical updates notification from a target Access Point (AP) Multi-Link Device (MLD) during seamless roaming;

FIG. 2 is a flow chart of a method for critical updates notification from a target AP MLD during seamless roaming; and

FIG. 3 is a block diagram of a computing device.

### DETAILED DESCRIPTION

### Overview

Critical updates notification from a target Access Point (AP) Multi-Link Device (MLD) during seamless roaming may be provided. A current AP MLD may receive a critical update notification from a target AP MLD during seamless roaming of a non-AP MLD to the target AP MLD from the current AP MLD. The critical update notification may be indicative of a change in a critical parameter at the target AP MLD after a roaming preparation phase of the seamless roaming. The current AP MLD may create a management frame comprising the critical update notification. The current AP MLD may send the management frame comprising the critical update notification to the non-AP MLD.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP) Multi-Link Devices (MLDs). Associating with a SMD may enable the STA to roam seamlessly between member AP MLDs of the SMD without requiring reassociation and reestablishment of contexts with each new AP MLD. That is, associating with an SMD may ensure that when the STA moves from the current AP MLD to a target AP MLD, the STA may not need to perform reassociation, reestablishment of contexts and rekeying, and the STA context may be transferred from the current AP MLD to the target AP MLD to achieve seamless roaming. In one example, rekeying may be performed in advance preparation done for seamless roaming. Thus, by enabling the STA to associate with a SMD that includes multiple member AP MLDs, the STA may significantly reduce roaming time to realize seamless roaming (e.g., smooth and continuous roaming with no apparent interruption in data communication) and significantly improve a STA’s wireless performance in terms of increased throughput, reduced latency, higher range, etc.

Seamless roaming may have two phases: a roaming preparation phase and a roaming execution phase. In the roaming preparation phase, the STA prepares a target AP MLD in advance for roaming transition in near future. The roaming preparation phase may involve link setup, context transfer, and Quality-of-Service (QoS) related resource reservation on the target AP MLD. Once a non-AP MLD (that is, the STA) has performed the roaming preparation with a target AP MLD, it then may perform the roaming execution to that target AP MLD to roam to that target AP MLD. The roaming execution phase may involve dynamic context transfer and changing a Distribution System (DS) mapping for the non-AP MLD from the current AP MLD to the target AP MLD.

In the IEEE 802.11bn seamless roaming, the links to the target AP MLD are setup during the roaming preparation phase. However, the non-AP MLD does not exchange any frames on these links until the conclusion of the roaming execution phase. Hence, the non-AP MLD may not receive any notification from the target AP MLD for the critical updates on the setup links. In addition, even after roaming execution is completed, there may be a Downlink Data Drain (DLDataDrain) time defined during which a non-AP MLD may receive buffered downlink data from the current AP MLD. This DLDataDrain time may be provided in a roaming execution response frame to a client (for example, a non-AP MLD) and the target AP MLD and can vary depending upon the amount of data buffered at the current AP MLD. A non-AP MLD may not be required to listen to beacons from the target AP MLD during the DLDataDrain time. This may be to avoid a single-radio non-AP MLD having to not go back and forth between the current AP MLD and the target AP MLD and enabling the non-AP MLD to retrieve the downlink data fast. However, not listening to the beacons from the target AP MLD may result in the non-AP MLD missing some critical updates (for example, regulatory related changes to transmit power, primary channel change, etc.) at the target AP MLD and may end up sending uplink data frames to the target AP MLD using old parameters. This may lead to unforeseeable issues based on type of critical updates that may have been missed.

One way to avoid these issues may include enforcing the non-AP MLD to listen to a beacon or perform a probe request/response exchange over one of the setup links of the target AP MLD to confirm that the non-AP MLD has the latest parameters for the setup links of the target AP MLD before it sends any uplink frames to the target AP MLD. However, this requirement may add to delay to the seamless roaming. Even performing the probe request/response exchange may add further delay to the seamless roaming thereby reducing roaming performance.

If critical updates are performed at the target AP MLD during a time from the roaming preparation response to the roaming execution exchange, or during the DLDataDrain time, the non-AP MLD may need to be notified of the critical updates so that the non-AP MLD has the latest parameters to use when connecting with the target AP MLD and performing data frame exchanges. The disclosure may provide a process where the non-AP MLD may be notified of any critical updates on the target AP MLD during the time from the roaming preparation response to the roaming execution exchange and during the DLDataDrain time through the current AP MLD. In one example implementation, the target AP MLD may notify the current AP MLD if any critical update happens at the target AP MLD on any of the setup links during the post roaming preparation phase until non-AP MLD completes roaming to the target AP MLD. The target AP MLD may also transfer details on the critical updates to the current AP MLD (for example, by sending an Ultra High Reliability (UHR) parameters update element) during these times. Then the current AP MLD may provide the critical update notification for the target AP MLD to the non-AP MLD. This may enable the non-AP MLD to receive or fetch the latest parameters of the setup links of the target AP MLD. Fetching the latest parameters may be important for regulatory related updates. In addition, this may minimize roaming time by avoiding the non-AP MLD to first fetch the latest parameters before data frame exchanges with the target AP MLD.

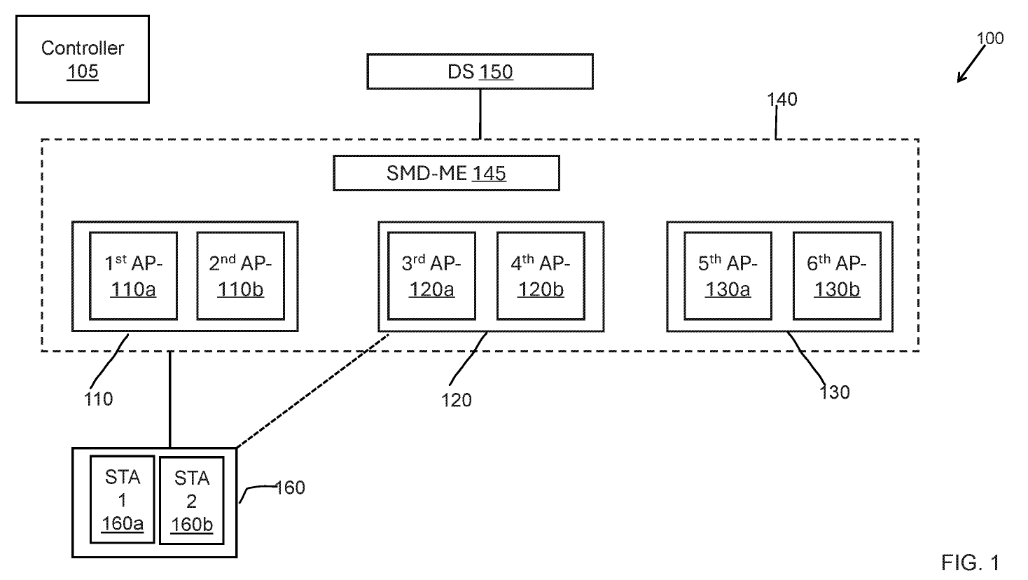

FIG. 1 is a block diagram of an operating environment 100 for critical updates notification from a target AP MLD during seamless roaming. As shown in FIG. 1, operating environment 100 may comprise a controller 105, a plurality of AP MLDs, for example, a first AP MLD 110, a second AP MLD 120, and a third AP MLD 130. Each of the plurality of AP MLDs may include one or more APs. For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include a SMD 140, an SMD Management Entity (SMD ME) 145, a DS 150, and a non-AP MLD 160. Non-AP MLD 160 may include a first STA 160a and a second STA 160b. SMD 140 includes a plurality of AP MLDs (that is, first AP MLD 110, second AP MLD 120, and third AP MLD 130) each with a Media Access Control (MAC)-Service Access Point (SAP) to DS 150.

SMD ME 145 may enable converged architecture for the plurality of AP MLDs of SMD 140. SMD ME 145 may enable an SMD mode for the plurality of AP MLDs. The SMD mode may enable non-AP MLD 160 to roam seamlessly between member AP MLDs without requiring reassociation and reestablishment of contexts with each new AP MLD. SMD ME 145 may be a logical entity and may be hosted on controller 105 or distributed on one or more of first AP MLD 110, second AP MLD 120, and third AP MLD 130. DS 150 may include wired ethernet or a mesh network used to connect multiple AP MLDs of SMD 140.

SMD 140 may provide a coverage environment, for example, but is not limited to, a Wireless LAN (WLAN) that may provide wireless network access (e.g., access to the WLAN for non-AP MLD 160 as it moves within the coverage environment). First STA 160a and second STA 160b each may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Each of the plurality of APs may be compatible with specification standards such as, but not limited to, the IEEE 802.11 specification standard for example. The plurality of APs and STAs of operating environment 100 may use Multi-Link Operation (MLO) where they simultaneously transmit and receive across different bands and channels by establishing two or more links to two or more AP radios. These bands may comprise, but are not limited to the 2.4 GHz band, the 5 GHz band, the 6 GHz band, and the 60 GHz band.

Controller 105 may comprise a WLC and may provision and control the coverage environment (for example, a WLAN). In some implementations of the disclosure, controller 105 may be implemented by a Digital Network Architecture Center (DNAC) controller (i.e., a Software-Defined Network (SDN) controller.

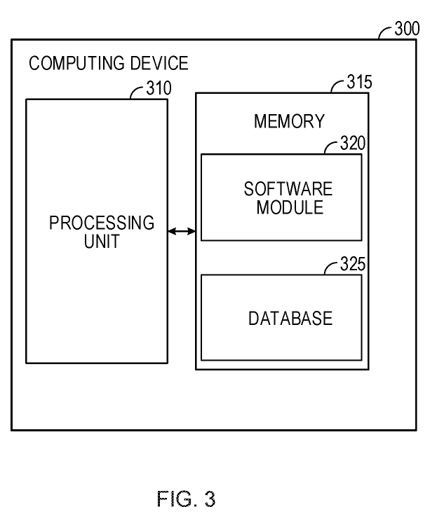

The elements described above of operating environment 100 (e.g., controller 105, first AP MLD 110, second AP MLD 120, third AP MLD 130, SMD 140, SMD ME 145, DS 150, and non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

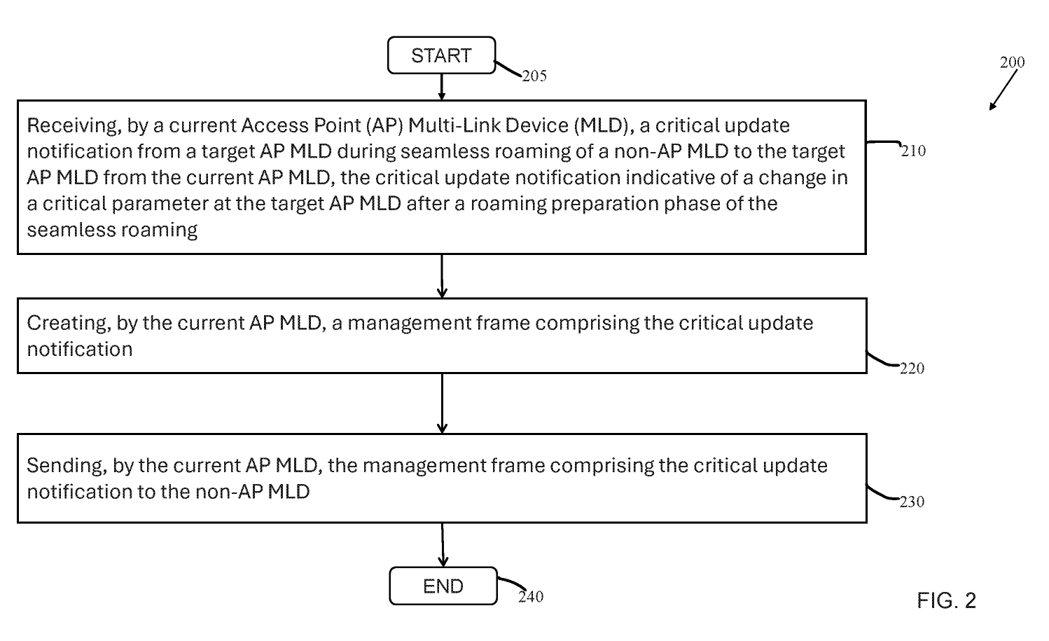

FIG. 2 is a flow chart setting forth the general stages involved in a method 200 consistent with implementations of the disclosure for critical updates notification from a target AP MLD during seamless roaming. Method 200 may be implemented using first AP MLD 110, second AP MLD 120, and non-AP MLD 160 as described in more detail above with respect to FIG. 1. In some examples, method 200 may be implemented using any of the plurality of AP MLDs of SMD 140 as described in more detail above with respect to FIG. 1. Ways to implement the stages of method 200 will be described in greater detail below.

Method 200 may begin at starting block 205 and proceed to stage 210 where a current AP MLD (for example, first AP MLD 110) may receive a critical update notification from a target AP MLD (for example, second AP MLD 120) during seamless roaming of non-AP MLD 160 to the target AP MLD (that is, second AP MLD 120) from the current AP MLD (that is, first AP MLD 110). The critical update notification may be indicative of a change in a critical parameter at the target AP MLD (that is, second AP MLD 120) after a roaming preparation phase of the seamless roaming at the target AP MLD (that is, second AP MLD 120) and before completion of the seamless roaming to the target AP MLD (that is, second AP MLD 120). In some examples, the critical updates may include parameters that affect link operability, regulatory compliance, including but not limited to: a channel switch using a Channel Switch Announcement (CSA) or an extended CSA announcing a quiet element or a quiet channel element; a Transmit Power Envelop (TPE) element related changes, a dropping off an affiliated AP, change in a channel condition, etc.

In one example, the target AP MLD (that is, second AP MLD 120) may be provided with a list of critical parameters or key parameters to be monitored for any updates after the roaming preparation phase at the target AP MLD (that is, second AP MLD 120). The target AP MLD (that is, second AP MLD 120) may constantly monitor the listed critical parameters or key parameters for any updates and may notify the current AP MLD (that is, first AP MLD 120) upon detecting a change in any of the listed critical parameters through the critical updated notification. In one example, the critical update notification from the target AP MLD (that is, second AP MLD 120) may be provided over a backhaul connection between the target AP MLD (that is, second AP MLD 120) and the current AP MLD (that is, first AP MLD 110). In some implementations, the critical update notification may be provided over DS 150. In some implementations, the critical update notification may also include the changed critical parameters, changes to the critical parameters, or updated parameters.

As discussed above, there may be a list of key critical updates defined such that when any of those critical updates happen, it may result in the target AP MLD (that is, second AP MLD 120) sending a critical update notification to the current AP MLD (that is, first AP MLD 110). In one example, if such critical updates notification is triggered from the target AP MLD (that is, second AP MLD 120) based on the set of key critical updates defined, then the target AP MLD (that is, second AP MLD 120) may also opportunistically piggyback any other non-key critical updates that may have happened at the target AP MLD (that is, second AP MLD 120) after the roaming preparation phase, besides any of the set of key critical updates. Then the management frame sent to non-AP MLD 160 may also include information for other non-key critical updates that have happened in per-STA profile subelements.

In some examples, when the roaming preparation timeout and/or the DLDrainTime is long (for example, from few 100s of msecs to few seconds), then multiple critical updates may happen at the target AP MLD (that is, second AP MLD 120) during that long period at different times. Then for each such critical update(s), the target AP MLD (that is, second AP MLD 120) may send a critical update notification to the current AP MLD (that is, first AP MLD 110). As described in the following sections, the current AP MLD (that is, first AP MLD 110) may then send a management frame to non-AP MLD 160 to provide notification of the critical update(s). In some implementations, the target AP MLD (that is, second AP MLD 120) may limit or minimize performing critical updates when it has active roaming preparation for non-AP MLD 160 or is aware of active DL data drain happening for non-AP MLD 160.

After receiving the critical update notification from the target AP MLD (that is, second AP MLD 120) at stage 210, method 200 may proceed to stage 220 where the current AP MLD (that is, first AP MLD 110) may create a management frame comprising the critical update notification. In one example, the management frame may include one of a UHR link reconfiguration notify frame (for example, with a new type value), an unsolicited BTM request frame, an unsolicited UHR link reconfiguration response frame, an unsolicited Neighbor Report Response (NRR) frame, an unsolicited neighbor probe response frame, an unsolicited Multi Link (ML) probe response frame, or another management/action frame.

The management frame may include an ML element that may provide the latest critical updates for any setup link of the target AP MLD (that is, second AP MLD 120) where critical updates may have happened. The critical updates may be provided in a basic ML element, a reconfiguration ML element, or another ML element, where per-STA profile may include respective element providing the updates, for example, a CSA element, an extended CSA element, a quiet element, a quiet channel element, an UHR parameters update element, or other elements related to the critical updates as defined for the UHR, Extended High Throughput (EHT), and previous generations.

In some implementations, the management frame may not include per-STA profile subelements for all the setup links for non-AP MLD 160. The management frame may only include per-STA profile subelements for those setup links that are setup and/or prepared for non-AP MLD 160 and where the critical updates may have happened. For example, if non-AP MLD 160 has setup or prepared a first link and a second link with the target AP MLD (that is, second AP MLD 120) and if critical updates have happened only on the second link, then the management frame may include the per-STA profile subelement only for the second link. Also, a STA profile field in the per-STA profile subelement for the link where critical updates has happened may only include relevant elements providing critical updates (for example, the ones listed above and other elements that can provide critical updates), and may not need to include complete profile for the link.

The management frame may provide a Basic Service Set (BSS) Parameters Change Count (BPCC) or an enhanced BPCC for each link where critical update may have happened. The BPCC or enhanced BPCC may be provided in the basic ML element or the reconfiguration ML element.

In some examples, the management frame may include a BSS Transition Management (BTM) request frame. A Neighbor Report (NR) element may be enhanced to include an element that may provide latest updated parameters for the target AP MLD links. For example, the BTM request may include UHR parameters update element in the NR element and may provide the critical update information for each link of the target AP MLD (that is, second AP MLD 120). The UHR parameters update element may provide the updated parameters for the target AP MLD link(s). The UHR parameters update element may be included as a part of an optional subelements field in the NR element.

In another example, a separate NR element may be included for each link of the target AP MLD (that is, second AP MLD 120) where critical update may have happened, and the NR element may include the UHR parameters update element providing the critical updates for each corresponding link. It may be beneficial to provide all relevant critical updates as well to non-AP MLD 160 as part of the management frame, so that no additional frame exchanges are needed with the target AP MLD (that is, second AP MLD 120) to fetch for updates.

Once having created the management frame comprising the critical update notification at stage 220, method 200 may proceed to stage 230 where the current AP MLD (that is, first AP MLD 110) may send the management frame comprising the critical update notification to non-AP MLD 160. After sending the management frame comprising the critical update notification to non-AP MLD 160 at stage 230, method 200 may terminate at END stage 240.

In an example implementation, when non-AP MLD 160 performs roaming execution via the target AP MLD (that is, second AP MLD 120), then non-AP MLD 160 may receive the latest parameters of affiliated APs of the links setup, if any critical update has happened since roaming preparation or since last critical updates notification sent to non-AP MLD 160 via the current AP MLD (that is, first AP MLD 110), as per procedure described above. In this implementation, the roaming execution response sent by the target AP MLD (that is, second AP MLD 120) directly to non-AP MLD 160 may include the link parameters for affiliated APs for the links where critical updates have happened.

In another example implementation, the roaming execution response directly sent from the target AP MLD (that is, second AP MLD 120) to non-AP MLD 160 may include the link parameters for all the setup links or only for links where critical updates have happened since roaming preparation or since last critical updates notification sent to non-AP MLD 160 via the current AP MLD (that is, first AP MLD 110). The roaming execution response may include a basic ML element, a reconfiguration ML element, or another ML element that may provide parameters for the affiliated APs in the per-STA profile subelements. The STA profile field may include a complete profile for the affiliated APs or partial profile that may provide only elements related to the critical updates.

In yet another implementation, when non-AP MLD 160 may be performing the DLDataDrain with current AP MLD (that is, first AP MLD 110), once it completes the DLDataDrain, non-AP MLD 160 may send a UHR link reconfiguration notify frame to notify the target AP MLD (that is, second AP MLD 120) of the termination of the DLDataDrain with the current AP MLD (that is, first AP MLD 110). Then if a critical update has happened at the target AP MLD (that is, second AP MLD 120), those updates may be provided in a response frame sent by the target AP MLD (that is, second AP MLD 120) to non-AP MLD 160, in response to receiving a UHR link reconfiguration notify frame for termination of the DL data drain. The target AP MLD (that is, second AP MLD 120) may send another UHR link reconfiguration notify frame (for example, with a Type value 2 or a different Type value) or another action frame or management frame (for example, a probe response or a BTM request) to non-AP MLD 160. The another UHR link reconfiguration notify frame may include a basic ML element, a reconfiguration ML element, or another ML element that may provide parameters for the affiliated APs in the per-STA profile subelements for the links where critical updates have happened. This another UHR link reconfiguration notify frame may be optional and may only be sent if a critical update has happened at the target AP MLD (that is, second AP MLD 120) post roaming preparation or after last critical update notification sent to non-AP MLD 160 via the current AP MLD (that is, first AP MLD 110) as per procedures described above.

### Critical Updates Indication in Roaming Execution Response

The link setup with the target AP MLD (that is, second AP MLD 120) may be performed as part of the roaming preparation. Non-AP MLD 160 may acquire the latest parameters for the setup links of the target AP MLD (that is, second AP MLD 160) as part of roaming preparation response. Non-AP MLD 160 may then perform the roaming execution which may need to be performed within a timeout value. The timeout value may be either indicated in the roaming preparation response or in an SMD wide timeout parameter indicated in a SMD specific element. In the roaming preparation response, non-AP MLD 160 may not receive any basic ML element from the target AP MLD (that is, second AP MLD 120) with the latest parameters for the setup links of the target AP MLD (that is, second AP MLD 120). The critical updates at the target AP MLD links may happen after the roaming preparation and before the roaming execution. In such a case, the target AP MLD (that is, second AP MLD 120) may provide the critical update notification to the current AP MLD (that is, first AP MLD 110) by transferring critical updates notification during the roaming execution exchange.

The current AP MLD (that is, first AP MLD 110) may receive the critical update notification from the target AP MLD (that is, second AP MLD 120) indicating that critical updates have happened since the roaming preparation as part of the roaming execution procedure. Then the current AP MLD (that is, first AP MLD 110) may provide this critical update notification to non-AP MLD 160 in the roaming execution response. The updated parameters for the target AP MLD (that is, second AP MLD 120) may also be provided in the roaming execution response, for example, in a UHR parameters update element for each setup link where critical updates may have happened. In one example, the updated parameters may be provided by including a basic ML element where a link specific per-STA profile may include the updated parameters for each setup link with the critical updates. In another example, the updated parameters may be provided by including a new ML element which can provide UHR parameters element for each setup link with the critical updates.

In another implementation, after the roaming preparation, when the critical updates happen at the target AP MLD (that is, second AP MLD 120) for any setup links for non-AP MLD 160 (or for any links of the target AP MLD(that is, second AP MLD 120)), the target AP MLD (that is, second AP MLD 120) may provide the critical update notification to the current AP MLD (that is, first AP MLD 110), and the current AP MLD (that is, first AP MLD 110) may send the critical update notification using a management frame or as part of a control frame to non-AP MLD 160 indicating critical updates have happened and may provide the updated parameters for the critical updates.

Thus, the critical updates at the target AP MLD (that is, second AP MLD 120) may happen either during the time from the roaming preparation response to roaming execution response exchange, or during the DLDataDrain time. It may be beneficial to notify non-AP MLD 160 if the critical updates happen during any of this time period. As discussed above, the critical update notification may be provided using one of the following ways: a) as part of roaming execution response frame; b) using a BTM request or another management frame; c) in A-Control frame during the DLDataDrain time; or d) using a control frame, for example, a Beamforming Service Request Protocol (BSRP) trigger frame or a multi-STA BA frame. In one example, options b), c) and d) may be used during the time from the roaming preparation response to the roaming execution exchange and/or during the DLDataDrain time.

It may also be beneficial to provide the updated parameters to non-AP MLD 160. This may ensure that non-AP MLD 160 either has the latest parameters for the target AP MLD (that is, second AP MLD 120) or knows that there may be a critical update and it may need to retrieve the latest parameters from the target AP MLD (that is, second AP MLD 120) before UL/DL frame exchanges.

### Capability Indication

A target AP MLD (for example, second AP MLD 120 or third AP MLD 130) may or may not support indicating the critical updates to the current AP MLD (that is, first AP MLD 110) for seamless roaming for a period from the roaming preparation to the roaming execution and during the DLDataDrain time. This capability may be indicated using a capability indication, for example, “Critical Update Notification Support during Seamless roaming”. An AP MLD may indicate this capability in a SMD element or another element. This capability may be provided per SMD (same capability for all AP MLDs of SMD 140) or this could be provided per AP MLD of SMD 140. An AP MLD may also indicate in the capability whether only an indication of the critical updates is provided or the critical update parameters are also provided from the target AP MLD (that is, second AP MLD 120).

Non-AP MLD 160 may learn whether the target AP MLD (that is, second AP MLD 120) provides this capability from the NR element or a probe response content of the target AP MLD (that is, second AP MLD 120) or the SMD element. If the capability is provided, non-AP MLD 160 may know whether a critical update happened or not during the seamless roaming procedure and may follow the processes described above. In one example implementation, only AP MLDs within the same SMD may provide this critical update notification to other neighboring AP MLDs in SMD 140.

If such a capability is not supported by the target AP MLD (that is, second AP MLD 120), then non-AP MLD 160 may not know whether any critical updates have happened and hence may need to first acquire the latest parameters from the target AP MLD (that is, second AP MLD 120) before data frame exchanges. Non-AP MLD 160 may acquire the latest parameters either using a probe request or response, or listening to a beacon.

Non-AP MLD 160 may get the latest BPCC for a UHR and EHT from the roaming preparation response in the basic ML element for all its accepted links at the target AP MLD (that is, second AP MLD 120). If non-AP MLD 160 didn’t receive critical update notifications from the target AP (that is, second AP MLD 120) during the seamless roaming procedure, then non-AP MLD 160 may use its BPCC state (received in the roaming prep response) to determine if it may need to acquire the updated parameters from a beacon or through a probe request or response.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for critical updates notification from a target AP MLD during seamless roaming as described above with respect to FIG. 2. Computing device 300, for example, may provide an operating environment for controller 105, first AP MLD 110, second AP MLD 120, third AP MLD 130, SMD 140, SMD ME 145, DS 150, and non-AP MLD 160. Controller 105, first AP MLD 110, second AP MLD 120, third AP MLD 130, SMD 140, SMD ME 145, DS 150, and non-AP MLD 160 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, by a current Access Point (AP) Multi-Link Device (MLD), a critical update notification from a target AP MLD during seamless roaming of a non-AP MLD to the target AP MLD from the current AP MLD, the critical update notification indicative of a change in a critical parameter at the target AP MLD after a roaming preparation phase of the seamless roaming;
creating, by the current AP MLD, a management frame comprising the critical update notification; and
sending, by the current AP MLD, the management frame comprising the critical update notification to the non-AP MLD.

2. The method of claim 1, wherein the management frame comprises an Ultra High Reliability (UHR) link reconfiguration notify frame.

3. The method of claim 2, further comprising:
providing updated parameters associated with the critical update notification in the management frame.

4. The method of claim 1, wherein upon receiving the management frame from the current AP MLD, the non-AP MLD is configured to fetch updated parameters associated with the critical update notification in the management frame from the target AP MLD.

5. The method of claim 1, wherein the management frame further comprises a Basic Service Set (BSS) Parameters Change Count (BPCC) or an enhanced BPCC for each link where the change in the critical parameter has happened.

6. The method of claim 1, further comprising:
indicating, by the target AP MLD, that it supports sending the critical update notification during the seamless roaming.

7. The method of claim 1, further comprising:
defining a list of critical parameters for the seamless roaming at the target AP MLD.

8. A system comprising:
a memory storage; and
a processing unit coupled to the memory storage, wherein the processing unit is operative to:
receive a critical update notification from a target Access Point (AP) Multi-Link Device (MLD) during seamless roaming of a non-AP MLD to the target AP MLD from a current AP MLD, the critical update notification indicative of a change in a critical parameter at the target AP MLD after a roaming preparation phase of the seamless roaming;
create a management frame comprising the critical update notification; and
send the management frame comprising the critical update notification to the non-AP MLD.

9. The system of claim 8, wherein the management frame comprises an Ultra High Reliability (UHR) link reconfiguration notify frame.

10. The system of claim 9, wherein the processing unit is further operative to:
provide updated parameters associated with the critical update notification in the management frame.

11. The system of claim 8, wherein upon receiving the management frame from the current AP MLD, the non-AP MLD is configured to fetch updated parameters associated with the critical update notification in the management frame from the target AP MLD.

12. The system of claim 8, wherein updated parameters associated with the critical update notification are provided in the management frame.

13. The system of claim 8, wherein the management frame further comprises a Basic Service Set (BSS) Parameters Change Count (BPCC) or an enhanced BPCC for each link where the change in the critical parameter has happened.

14. The system of claim 8, wherein the processing unit is further operative to:
indicate that it supports sending the critical update notification during the seamless roaming.

15. A non-transitory computer-readable medium that stores a set of instructions which when executed perform a method executed by the set of instructions comprising:
receiving, by a current Access Point (AP) Multi-Link Device (MLD), a critical update notification from a target AP MLD during seamless roaming of a non-AP MLD to the target AP MLD from the current AP MLD, the critical update notification indicative of a change in a critical parameter at the target AP MLD after a roaming preparation phase of the seamless roaming;
creating, by the current AP MLD, a management frame comprising the critical update notification; and
sending, by the current AP MLD, the management frame comprising the critical update notification to the non-AP MLD.

16. The non-transitory computer-readable medium of claim 15, wherein the management frame comprises an Ultra High Reliability (UHR) link reconfiguration notify frame.

17. The non-transitory computer-readable medium of claim 16, further comprising:
providing updated parameters associated with the critical update notification in the management frame.

18. The non-transitory computer-readable medium of claim 15, wherein the management frame further comprises a Basic Service Set (BSS) Parameters Change Count (BPCC) or an enhanced BPCC for each link where the change in the critical parameter has happened.

19. The non-transitory computer-readable medium of claim 15, further comprising:
indicating, by the target AP MLD, that it supports sending the critical update notification during the seamless roaming.

20. The non-transitory computer-readable medium of claim 15, further comprising:
defining a list of critical parameters for the seamless roaming at the target AP MLD.
